(19) United States
(12) Patent Application Publication
(10) Pub. No.: US 2014/0223028 A1
(43) Pub. Date: Aug. 7, 2014

(54) Sharing Data Among Smart Devices and a Cloud Network

(71) Applicants: Paul J. Peng, Beijing (CN); Sun C. Chan, Fremont, CA (US); Michael P. Mesnier, Scappoose, OR (US); Dawei Wang, Beijing (CN)

(72) Inventors: Paul J. Peng, Beijing (CN); Sun C. Chan, Fremont, CA (US); Michael P. Mesnier, Scappoose, OR (US); Dawei Wang, Beijing (CN)

(21) Appl. No.: 13/993,007

(22) PCT Filed: Dec. 30, 2011
(86) PCT No.: PCT/US2011/068057

§ 371 Date: Jun. 10, 2013

(51) Int. Cl. H04L 29/08

(52) U.S. Cl. CPC H04L 67/10
USPC 709/246

(57) ABSTRACT

In accordance with some embodiments, raw data in a first data format may be generated or received. Then, the raw data may be transformed to cloud data in a second data format. Finally, the cloud data may be transformed into device data in a third data format.

### BACKGROUND

This relates generally to computer systems and more particularly, to sharing data among computer systems.

The rise of smart devices and their interactions with cloud networks have presented numerous forms of data usage. For example, a digital camera may be capable of taking photos and videos and then publishing such media to a cloud network such as Facebook. A different device, such as an Internet capable television, may then be capable of accessing Facebook and presenting the published media to a user. Thus, data sharing among these devices and cloud networks can provide a powerful tool for enhancing a user's interactive media experience.

However, there are a multitude of smart devices on the market, each configured to manage different types of data formats. In the above example, data generated by the digital camera when taking a photo may be unrecognizable to the Internet capable television. Thus, difficulties may exist with respect to raw data sharing among devices and cloud networks.

Additionally, users of the devices may desire particular configurations in managing their data. For instance, a user may desire to prevent the device from sharing particular types of data, such as any data representative of a self-portrait photo. Therefore, using predefined data sharing policies may be unable to satisfy such varied user-defined requirements.

Furthermore, storage within cloud networks may be typically implemented using a database framework for storing large, static, and unstructured data. Additionally, some cloud networks may be even more unstructured in using only special purpose file systems instead of a database to store this data. Conversely, devices typically generate smaller instances of dynamic data. As a result, cloud storage may not be designed for the small random access associated with device data. Thus, optimization of cloud network storage may also merit consideration in the context of data sharing among devices and cloud networks.

### BRIEF DESCRIPTION OF THE DRAWINGS

FIG. 1 is a system depiction for one embodiment of the present invention;

FIG. 2 is a system depiction for another embodiment of the present invention;

FIG. 3 is a block diagram for another embodiment of the present invention; and

FIG. 4 is a system depiction for another embodiment of the present invention.

FIG. 5 is a flow diagram for another embodiment of the present invention.

### DETAILED DESCRIPTION

In accordance with some embodiments, a cloud network may receive raw data from a first device. To this end, the raw data may be generated by the first device in a first data format. Upon receiving the raw data, the cloud network may initiate a transformation process to transform the raw data to cloud data. More specifically, the cloud network may transform the raw data to cloud data from the first data format into a second data format.

Thereafter, a second device may wish to access the data represented by both the raw data in the first device and the cloud data in the cloud network. However, the second device may be unable to recognize data stored in either the first data format or the second data format. After communication is established between the cloud network and the second device, the cloud network may recognize that the second device may require the data to be stored in a third data format. Thus, the cloud network may transform the cloud data in the second data format to device data in a third data format. Then, the cloud network may send the device data to the second device. Thus, data may be shared among the first device, the second device, and the cloud network even though each of these entities may store the data in separate formats.

In another embodiment, the first device may perform the transformation process to transform the raw data to cloud data. Furthermore, cloud data may be smaller in size than raw data. Thus, transmission from the first device to the cloud network may be performed on a smaller size of data. Additionally, performing the transformation process on the first device may provide relatively higher levels of privacy and security for a user of the first device.

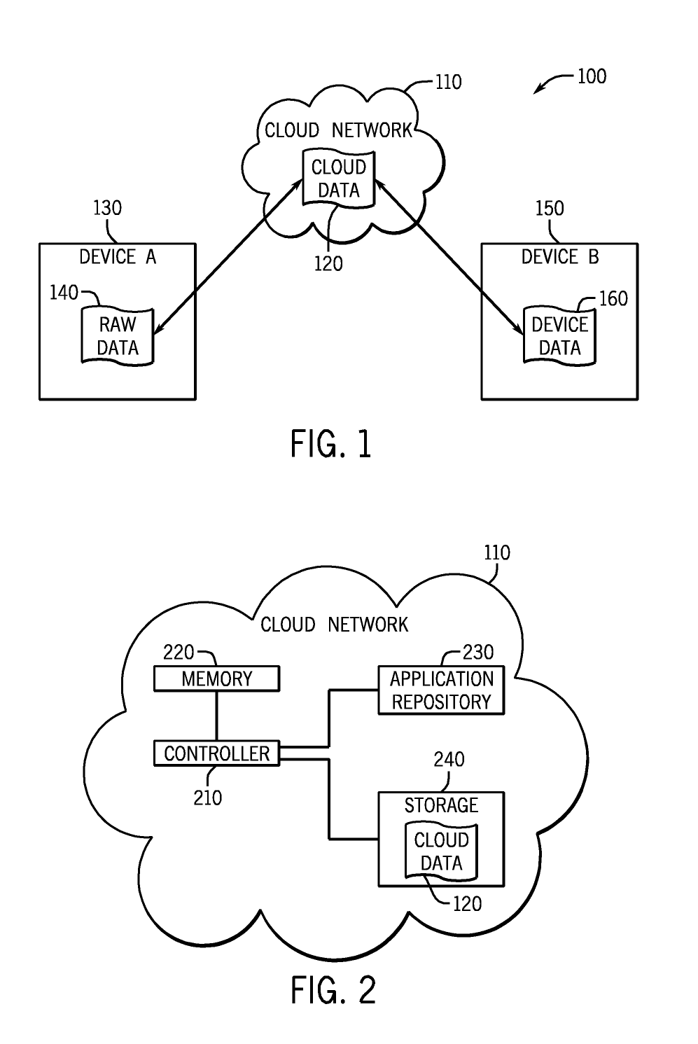

Referring now to FIG. 1, a system 100 is provided for sharing data among devices and a cloud network 110. A first device, represented by device A 130, may be capable of generating raw data 140. Raw data 140 may be generated and stored in a first data format by device A 130. In general, raw data 140 may be data that is directly generated from a particular source. In some embodiments, raw data 140 may be data that has not been subjected to any processing or other data manipulation or that has experienced only relatively minimal processing. For example, device A 130 may be any data generating device such as a camera or video recorder. As such, device A 130 may generate image files in a multitude of different raw image formats represented by file extensions that include, but are not limited to, .raw, .crw, .orf, .dng, .bay, and .mos.

In an embodiment depicted in FIG. 1, device A 130 may wish to share its raw data 140 with device B 150. However, device B 150 may be incapable of reading the raw data 140 in its first data format. Thus, device A may communicate with cloud network 110 in order to share raw data 140 with other devices. Such communication may be established over any of various known networking means such as a Local Area Network (LAN), Wide Area Network (WAN), the Internet, or any other networking protocols. Additionally, the communication may be conducted using any standard such as Ethernet, WiFi, Bluetooth, and/or any other communication protocols.

The cloud network 110, which will be more fully described with reference to FIG. 2, may be able to receive raw data 140 from device A 130. In one embodiment, the cloud network 110 may store data in a second data format. As such, the cloud network may be capable of transforming the raw data 140 in the first data format to cloud data 120 in the second data format. In some embodiments, the second data format may enable optimal storage of the cloud data in a database. For example, the second data format may enable relatively fast storing and fetching of cloud data within a database in the cloud network.

Moreover, in other embodiments, the cloud network 110 may include cloud networks of multiple cloud service providers. For example, other cloud services can include Amazon S3, Google Storage, Hardoop, and any other cloud service provider. As such, each of these service providers may store the cloud data 120 in different formats. To this end, the cloud network 110 may be capable of virtualizing these different service providers to device A 130 and/or device B 150. Thus, depending on which particular service provider device A 130 wishes to associated raw data 140 with, the cloud network 110 may store the cloud data 120 in the particular service provider using a second data format recognized by the particular service provider.

Furthermore, communication between the cloud network 110 and device B 150 may be established in order to share the raw data 140 of device A 130 with device B 150. As previously discussed, device B may be unable to read or process data in the first data format and/or the second data format. As such, the cloud network 110 may be capable of transforming the cloud data 120 in the second data format to device data in the third data format 160. Thereafter, the cloud network 110 may send the device data 160 to device B 150 to be stored. Alternatively, device B 150 may itself pull the device data 160 from the cloud network 110.

In some embodiments, the process of transforming data from one format to another may be performed during data transmission. For instance, raw data 140 may be transformed into cloud data 120 during transmission from device A 130 to cloud network 110. Similarly, cloud data 120 may be transformed into device data 160 during transmission from the cloud network 110 to device B 150.

In other embodiments, transforming the raw data 140 to cloud data 120 may be performed by device A 130 before transmission to the cloud network 110. In yet another embodiment, device A 130 may communicate directly with device B 150 without participation of the cloud network 110. Thus, each device may be capable of performing the transformation processes from what data format to another. For example, device A 130 and/or device B 150 may be capable of transforming raw data 140 to device data 160.

Thus, the raw data 140, cloud data 120, and device data 160 may all represent the same data originally generated as raw data 140 in device A, but may be stored in three different data formats. In some embodiments, data consistency may be maintained between raw data 140, cloud data 120, and device data 160. In other words, changes to any one of the three mentioned data elements may be propagated to the other two data elements. Such data consistency may be maintained despite the fact that all three data elements may be stored in separate data formats. To this end, each of the cloud network 110, device A 130, and device B 150 may be referred to as having the same “view” of the data elements.

In one embodiment, in order to maintain the aforementioned data consistency, a synchronization procedure may be initiated by one of the cloud network 110, device A 130, or device B 150 if a change is made to its respective data. For example, if a change is made to cloud data 120, in the cloud network 110, such changes may be propagated to device A 130 and device B 150. If a change is made to the raw data 140 in device A or device data 160 in device B 150, such changes may be propagated to the cloud network 110 and then propagated to the other device or devices, etc.

In some embodiments, each of the device A 130 and device B 150 may be any electronic device capable of generating and consuming data. Such devices may include, but are not limited to, mobile phones, laptops, desktop computers, cameras, video recorder, personal digital assistants, tablet computers, and/or netbooks. Furthermore, while FIG. 1 depicts only one cloud network 110 and two devices in device A 130 and device B 150, it should be understood that any number of devices among any number of cloud networks may also be contemplated within the present disclosure.

Turning now to FIG. 2, a more detailed depiction of the cloud network 110 is provided. The cloud network 110 network may include a controller 210, which may be coupled to a memory 220, an application repository 230, and a storage 240 storing cloud data 120. The controller 210 may include any electronic device, such as a processor for example, capable of executing computer instructions. For instance, the controller 210 may load an operating system into memory 220 in order to interact with the application repository 230 and the storage 240. As another example, the controller 210 may process instructions store or fetch data from the storage 240.

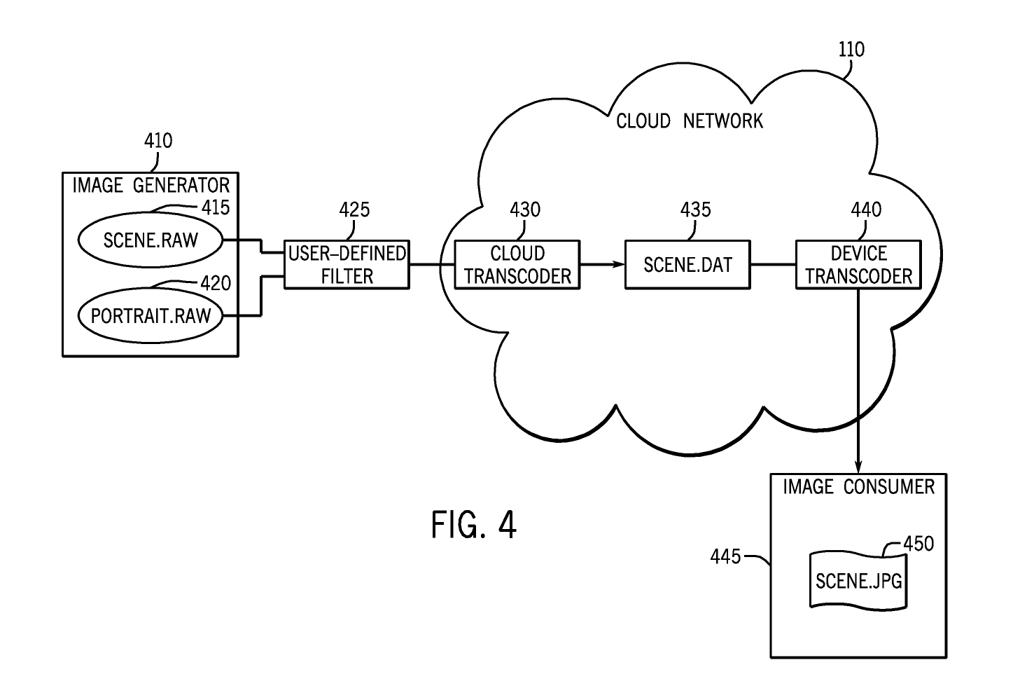

The application repository 230 may store transformation applications. In one embodiment, transformation applications may be invoked or executed when transforming data from one data format to another data format. In another embodiment, transformation applications may be loaded by a device to execute user-defined configurations. Specific transformation applications may be discussed later with reference to FIG. 4.

Storage 240 may represent any storage device or devices including hard disk drives, solid state drives, flash memory, tape drives, optical drives, and/or any other storage means. In one embodiment, the storage 240 may include a database for storing cloud data 120 in a particular data format optimized for database storage. For example, the cloud data 120 may be stored in a data format with the file extension .dat.

Thus, in some embodiments, the controller 210 may be capable of executing instructions to load a transformation application from the application repository 230 into memory 220. The controller 210 may then execute instructions to transform data from one data format into another data format using the transformation application. For example, the controller 210 may load a transformation application to transform raw data 140 into cloud data 120.

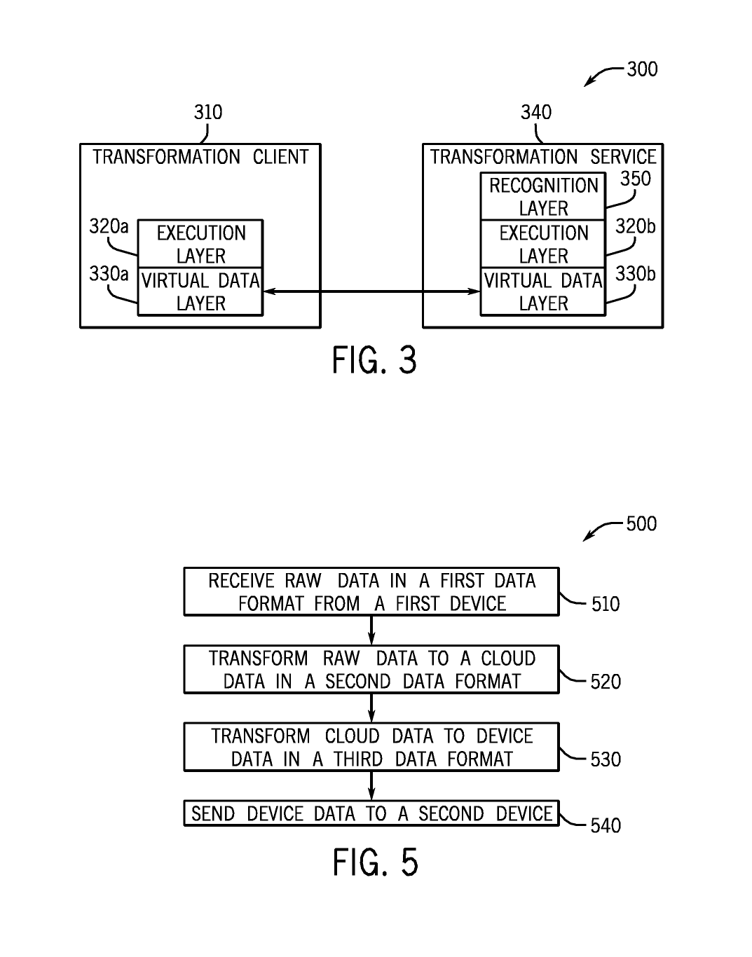

FIG. 3 represents a block diagram depicting a system 300 for communication between devices and a cloud network 110. The system 300 may include a transformation client 310 and a transformation service 340. In one embodiment, communication between devices, such as device A 130 and/or device B 150, may be established with the cloud network 110 using a client-service architecture. Thus, the transformation client 310 may be an application stored on and executed by a device (e.g., device A 130 and/or device B 150); the transformation service 340 may be an application stored on and executed by the cloud network 110.

As depicted in FIG. 3, the transformation client 310 may include an execution layer 320a and a virtual data layer 330a. Similarly, the transformation service 340 may also include an execution layer 320b and virtual data layer 330b. In addition, the transformation service 340 may include a device recognition layer 350.

The respective virtual data layers 330a, 330b may enable the transformation client 310 and the transformation service 340 to have the same “view” of two data elements that represent the same information but are stored in different data formats. For instance, consider a scenario where device A 130 executes a transformation client 310 and where device A 130 stores a raw image file in a .raw format. Furthermore, cloud network 110 may execute a transformation service 340 and may store an image file in a .dat format corresponding to the same image stored in the raw image file. The respective virtual data layers 330a, 330b may enable device A 130 and the cloud network 110 to recognize the two image files stored in two different data formats as representing the same image. Thus, in some embodiments, the virtual data layers 330a, 330b may be compatible with data in multiple data formats.

In one embodiment, the cloud network 110 may include multiple cloud service providers in communication with each other. Thus, the virtual data layer 330b on the cloud network 110 may enable the cloud network 110 to virtualize the different cloud service providers to any devices executing the transformation client 310.

The executions layers 320a, 320b may allow the devices executing the transformation client 310 and the transformation service 340 to respectively execute transformation applications. As previously discussed, the transformation applications may be stored in the application repository 230 of the cloud network 110. In one embodiment, the execution layers 320a, 320b may be implemented as plug-ins to the transformation client 310 and the transformation service 340, respectively.

The device recognition layer 350 may enable the transformation service 340, or a device running the transformation service 340, to identify a device (and its characteristics) executing a transformation client. Furthermore, the recognition layer 350 may allow the transformation service 340 to identify a particular data format that is associated with the device executing the transformation client 310. In one embodiment, the recognition layer 350 may also provide a mechanism for the transformation service 340 to authenticate a transformation client 310, such as through a log-in and password.

Though FIG. 3 illustrates a client-service architecture, the present disclosure also contemplates a peer-to-peer framework. As previously discussed user devices, such as device A 130 and device B 150, may communicate with each other directly without involving the cloud network 110. Thus, some or all of the components of the cloud network 110 may also be located in any of the user devices. For example, the application repository 230 may be stored on device A 130, device B 150, or both.

FIG. 4 illustrates another embodiment of a system for sharing data among devices and the cloud network. The system may include a cloud network 110, an image generator 410, and an image consumer 445. The cloud network 110 may be in communication with the image generator 410 and the image consumer 445 in order to facilitate the sharing of data between the image generator 410 and the image consumer 445. In one embodiment, the image generator 410 may correspond to device A 130 while the image consumer 445 may correspond to device B 150.

As one example, the image generator 410 may store two image files including scene.raw 415 and portrait.raw 420. In one embodiment, scene.raw 415 may represent a scenery image while portrait.raw may represent a portrait image of a person. Moreover, the image generator 410 may be configured such that its image files are automatically uploaded to the cloud network 110. However, a user of the image generator 410 may not want portrait images to be automatically shared or uploaded to the cloud network 110. Therefore, a user-defined filter 425 may be used to filter out portrait images before allowing image files in the image generator 410 to be uploaded to the cloud network. In one embodiment, the user-defined filter 425 may be a particular transformation application loaded by the image generator 410 from the application repository 230 in the cloud network 110.

Cloud transcoder 430 may represent another transformation application loaded from the application repository. In one embodiment, the cloud network 110 may invoke the cloud transcoder 430 specifically for transforming files in a data format associated with the image generator 410 to a data format the cloud network uses 110. To this end, the cloud transcoder 430 may be used to transform image files in the .raw format to an image file in the .dat format for storage in the cloud network 110. In the example depicted in FIG. 4, cloud transcoder 430 may be used to transform scene.raw 415 into scene.dat 435, while portrait.raw 420 may have been filtered out by the user-defined filter 425. The scene.dat 435 image file may be optimized for storage in a database of the cloud network.

As depicted in FIG. 4, the image consumer 445 may wish to access the scene image shared by the image generator 410. However, the image consumer 445 may only recognize image files in a certain data format, such as .jpg for example. Thus, the cloud network 110 may identify the data format requirements of the image consumer 450 and invoke device transcoder 440 from the application repository 230. As a result, the device transcoder 440 may transform scene.dat 435 into scene.jpg 450 for storage on the image consumer 450. Therefore, through the cloud network 110, the image generator 410 may be able to share image files with an image consumer 450 though each device may store image files in a separate data format.

In one embodiment, the cloud transcoder 430 and the device transcoder 440 may be executed respectively during transmission of files between the image generator 410 and the cloud network 110 and between the cloud network 110 and the image consumer 445. In another embodiment, the cloud transcoder 430 and device transcoder 440 may be executed in the cloud exclusively. In yet another embodiment, they may be executed in the appropriate devices (e.g., image generator 410 and/or image consumer 445). In another embodiment, they may be executed in a combination of the cloud network 110 and the devices.

Furthermore, data consistency may be maintained among scene.raw 415, scene.dat 435, and scene.jpg 450. In other words, changes to any one of the scene images may be propagated to the other scene images.

It should be noted that FIG. 4 illustrates only one example of a system for sharing data among devices and a cloud network and that other components and configurations are also possible. For example, any number of devices may be included in the system. Additionally, the devices are not limited to managing image files. Instead of generating and consuming images, the devices may be able to manage audio data, video data, documents, or any other type of data. Furthermore, other types of transformation applications are also contemplated. For instance, one use of a transformation application may be to encrypt certain data files while. Another use may be to execute compression algorithms on the data. Still a further use may to be merge data with other data. In general, a transformation application may be implemented for any user-defined criteria.

Moreover, the present disclosure is not limited to the particular data formats depicted in FIG. 4. It should be generally understood by one of ordinary skill in the art that multiple data formats are possible with respect the devices (e.g., image generator 410 and image consumer 445) and the cloud network 110.

FIG. 5 illustrates a flow-diagram representing a method 500 for sharing data among devices and a cloud network. The method 500 may be depicted from the perspective of the cloud network 110. In step 510, the cloud network 110 may receive raw data in a first device format from a first device. In step 520, the cloud network may invoke or execute a transformation application from its application repository 230 to transform the raw data to cloud data in a second data format.

Thereafter, in step 530, the cloud network 100 may use another transformation application to transform the cloud data to device data in a third data format. In step 540, the cloud network 110 may send the device data to a second device.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving, at a cloud network, raw data in a first data format from a first device;
transforming the raw data in the first data format into cloud data in a second data format for storage in the cloud network;
transforming the cloud data in the second data format into device data in a third data format; and
sending, from the cloud network, the device data to a second device.

2. The method of claim 1, wherein the cloud network comprises an application repository storing a plurality of transformation applications.

3. The method of claim 2 further comprising invoking a first transformation application from the application repository to transform the raw data in the first data format into cloud data in the second data format.

4. The method of claim 3 further comprising invoking a second transformation application from the application repository to transform the cloud data in the second data format into device data in the third data format.

5. The method of claim 4 further comprising sending a third transformation application to the first device to filter out data content on the first device according to a user-defined configuration.

6. The method of claim 1, wherein transforming the raw data in the first data format to cloud data in the second data format is performed on the cloud network during transmission of the raw data from the first device to the cloud network.

7. The method of claim 1, wherein each of the first device, the second device, and the cloud network comprises a virtual data layer.

8. The method of claim 7 further comprising using each respective virtual data layer to enable data consistency between the first device, the second device, and the cloud network.

9. The method of claim 1, wherein communication between the first device, the second device, and the cloud network is established using a client-service architecture.

10. The method of claim 1, wherein the cloud network comprises a device recognition layer to determine appropriate data formats associated with respective devices.

11. A system comprising:
a cloud network storing a cloud transcoder and a device transcoder, wherein the cloud transcoder is to receive raw data in a first data format and transform the raw data in the first data format into cloud data in a second data format for storage in the cloud network, and wherein the device transcoder is to transform the cloud data in the second data format into device data in a third data format.

12. The system of claim 11, wherein the cloud network comprises an application repository storing a plurality of transformation applications.

13. The system of claim 12, wherein the cloud transcoder comprises a particular transformation application loaded from the application repository.

14. The system of claim 12, wherein the device transcoder comprises a particular transformation application loaded from the application repository.

15. The system of claim 12 wherein the cloud network loads a particular transformation application from the application repository to filter out data content according to a user-defined configuration.

16. The system of claim 11, wherein transforming the raw data in the first data format to cloud data in the second data format is performed during transmission of the raw data from a user device to the cloud network.

17. The system of claim 16, wherein the user device and the cloud network each comprises a virtual data layer.

18. The system of claim 17 further comprising using each respective virtual data layer to enable data consistency between the user device and the cloud network.

19. The system of claim 11, wherein communication between the user device and the cloud network is established using a client-service architecture.

20. The system of claim 11, wherein the cloud network comprises a device recognition layer to determine appropriate data formats associated with respective devices.

21. A non-transitory computer readable medium to store instructions executable by a processor, the instructions comprising:
receiving, at a cloud network, raw data in a first data format from a first device;
transforming the raw data in the first data format into cloud data in a second data format for storage in the cloud network;
transforming the cloud data in the second data format into device data in a third data format; and
sending, from the cloud network, the device data to a second device.

22. The medium of claim 21, wherein the cloud network comprises an application repository storing a plurality of transformation applications.

23. The medium of claim 22, wherein the instructions further comprise invoking a first transformation application from the application repository to transform the raw data in the first data format into cloud data in the second data format.

24. The medium of claim 23, wherein the instructions further comprise invoking a second transformation application from the application repository to transform the cloud data in the second data format into device data in the third data format.

25. The medium of claim 24, wherein the instructions further comprise sending a third transformation application to the first device to filter out data content on the first device according to a user-defined configuration.

26. The medium of claim 21, wherein transforming the raw data in the first data format to cloud data in the second data format is performed on the cloud network during transmission of the raw data from the first device to the cloud network.

27. The medium of claim 21, wherein each of the first device, the second device, and the cloud network comprises a virtual data layer.

28. The medium of claim 27 further comprising using each respective virtual data layer to enable data consistency between the first device, the second device, and the cloud network.

29. The medium of claim 21, wherein communication between the first device, the second device, and the cloud network is established using a client-service architecture.

30. The medium of claim 21, wherein the cloud network comprises a device recognition layer to determine appropriate data formats associated with respective devices.
